(19) United States
(12) Patent Application Publication
(10) Pub. No.: US 2025/0094579 A1
(43) Pub. Date: Mar. 20, 2025

(54) METHODS AND SYSTEMS FOR DETECTING, VIA RESOURCE-LEVEL ENTROPY CHECKS, RESOURCES HAVING ANOMALOUS ATTRIBUTES

(71) Applicant: Alcion, Inc., Santa Clara, CA (US)

(72) Inventors: Zachary Rossman, San Clemente, CA (US); Eno Thereska, Cambridge (GB); Georgi Milkov Matev, San Francisco, CA (US)

(21) Appl. No.: 18/888,484

(22) Filed: Sep. 18, 2024

Related U.S. Application Data
(60) Provisional application No. 63/575,547, filed on Apr. 5, 2024.
(60) Provisional application No. 63/538,927, filed on Sep. 18, 2023.

(51) Int. Cl. G06F 21/56

(52) U.S. Cl. CPC G06F 21/56

(57) ABSTRACT

A method for detecting, by a ransomware detection system, via at least one resource-level entropy check during a process for transmitting a plurality of resource to a data backup system, a resource in the plurality of resources having an anomalous attribute includes generating, by the ransomware detection system, a first machine learning model associated with a first type of resource associated with at least one resource in the plurality of resources. The ransomware detection system determines that a first resource in the plurality of resources is associated with the first type, the determining occurring prior to transmission of a second resource in the plurality of resources to the data backup system. The ransomware detection system analyzes, using the first machine learning model. The ransomware detection system determines that the first resource is anomalous. The ransomware detection system transmits an alert of the determination that the first resource is anomalous.

### CROSS-REFERENCE TO RELATED APPLICATIONS

This application claims priority from U.S. Provisional Patent Application No. 63/538,927, filed on Sep. 18, 2023, entitled “Methods and Systems for Per-Resource Anomaly Detection,” and from U.S. Provisional Patent Application No. 63/575,547, filed on Apr. 5, 2024, entitled “Methods and Systems for Per-Resource Anomaly Detection,” each of which is hereby incorporated by reference.

### BACKGROUND

The disclosure relates to methods for detecting anomalous attributes. More particularly, the methods and systems described herein relate to functionality for detecting, by a ransomware detection system, via at least one resource-level analyses, including an entropy check, during a process for transmitting a plurality of resources to a data backup system, a resource in the plurality of resources having an anomalous attribute.

Ransomware represents a credible, high-severity threat to every business, irrespective of the business size or sector and the capabilities of ransomware continue to evolve. Companies face increasingly frequent and sophisticated ransomware attacks. Early detection is of importance when it comes to cyber-attack response—the sooner system administrators are alerted to an attack, the sooner they can isolate the infected systems and protect any remaining unencrypted data; this, in turn, reduces the leverage of the bad actor. Although there are approaches that attempt to provide improved detection times, such approaches do not typically check files (or other resources) on a file-by-file basis, given the time and resource consumption such an approach would typically require. Other conventional approaches execute after a process has completed a back-up and stored back-up data in persistent storage, which delays execution of ransomware analysis processes and requires the querying and retrieval of data from persistent storage.

Therefore, there is a need for technological improvements to systems for identifying anomalous resources to enable analyzing and detecting, at a per-resource level, resources having anomalous attributes during a process for transmitting a plurality of resource to a data backup system.

### SUMMARY

In one aspect, a method for detecting, by a ransomware detection system, via at least one resource-level attribute analysis-such as an entropy check—during a process for transmitting a plurality of resource to a data backup system, a resource in the plurality of resources having an anomalous attribute includes generating, by a ransomware detection system, a first machine learning model associated with a first type of resource associated with at least one resource in a plurality of resources transmitted to a data backup system. The method includes determining, by the ransomware detection system, that a first resource in the plurality of resources is associated with the first type, the determining occurring prior to transmission of a second resource in the plurality of resources to the data backup system. The method includes analyzing, by the ransomware detection system, using the first machine learning model, the analyzing occurring prior to transmission of the second resource to the data backup system. The method includes determining, by the ransomware detection system, prior to transmission of the second resource in the plurality of resources to the data backup system, based on the analysis, that the first resource is anomalous. The method includes transmitting, by the ransomware detection system, an alert of the determination that the first resource is anomalous.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for detecting resources having anomalous attributes;

FIG. 1B is a block diagram depicting an embodiment of a user interface generated by a system for detecting resources having anomalous attributes;

FIG. 1C is a block diagram depicting an embodiment of a system for detecting resources having anomalous attributes;

FIG. 2 is a flow diagram depicting an embodiment of a method for detecting resources having anomalous attributes;

FIG. 3A is a flow diagram depicting an embodiment of a method for detecting resources having anomalous attributes;

FIG. 3B is a flow diagram depicting an embodiment of a method for detecting resources having anomalous attributes; and

FIGS. 4A-4C are block diagrams depicting embodiments of computers useful in connection with the methods and systems described herein.

### DETAILED DESCRIPTION

The methods and systems described herein may provide functionality for detecting resources having anomalous attributes. More particularly, the methods and systems described herein relate to functionality for detecting, by a ransomware detection engine, via at least one resource-level entropy check at the per-resource level, during a process for backing up a plurality of resources. The methods and systems described herein may relate to functionality for detecting, by a ransomware detection engine, via at least one resource-level attribute analysis at the per-resource level, during a process for backing up a plurality of resources; the attribute analysis may include the resource-level entropy check. The analysis of one or more resources may be focused on and/or limited to analysis of resources associated with a particular subject (e.g., a user, group of users, organizational unit, and/or other entity associated with a data source transmitting the plurality of resources to the systems described herein).

In one embodiment, the methods and systems described herein execute a cloud-native ransomware detection engine. Execution of such methods and systems may result in improved levels of accuracy and cost efficiency in detecting ransomware.

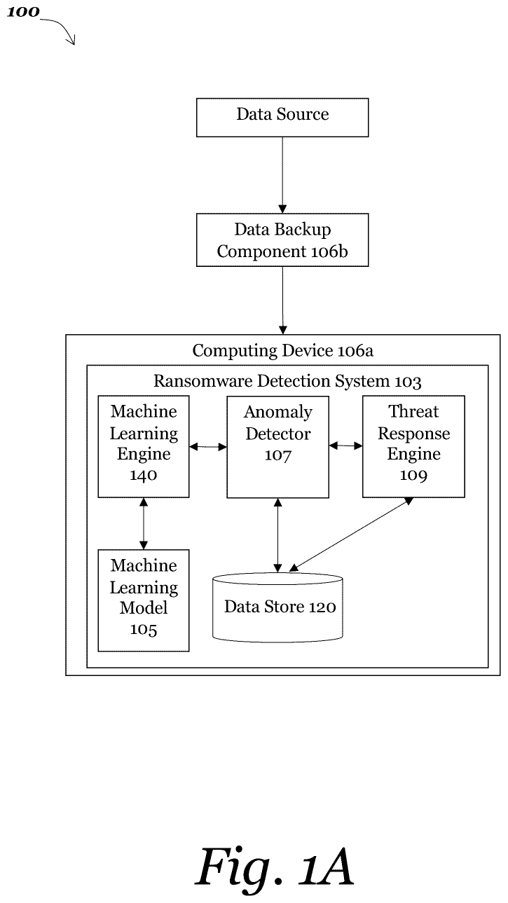

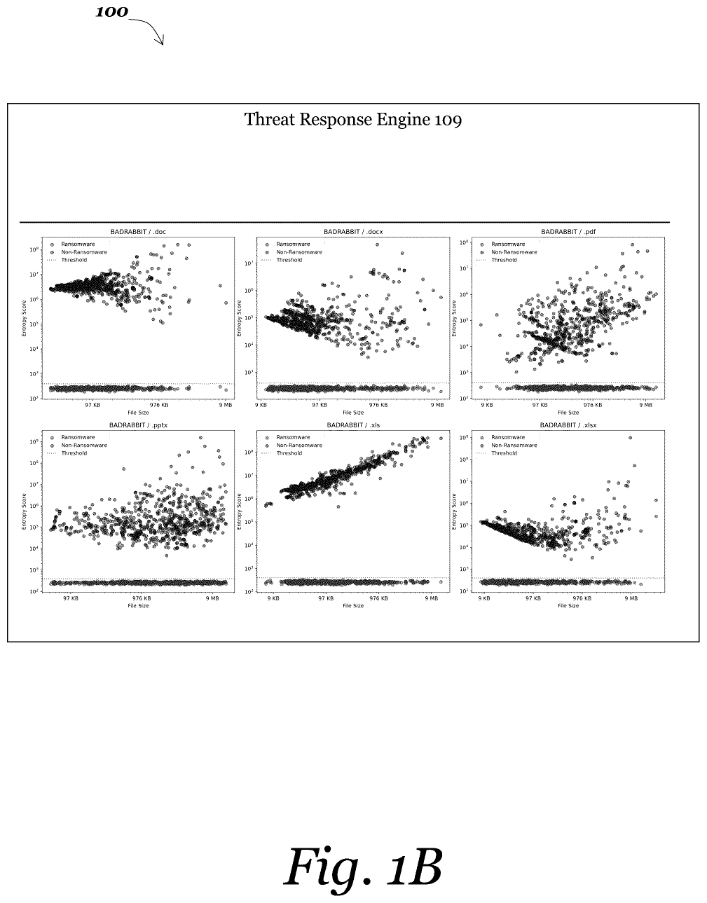

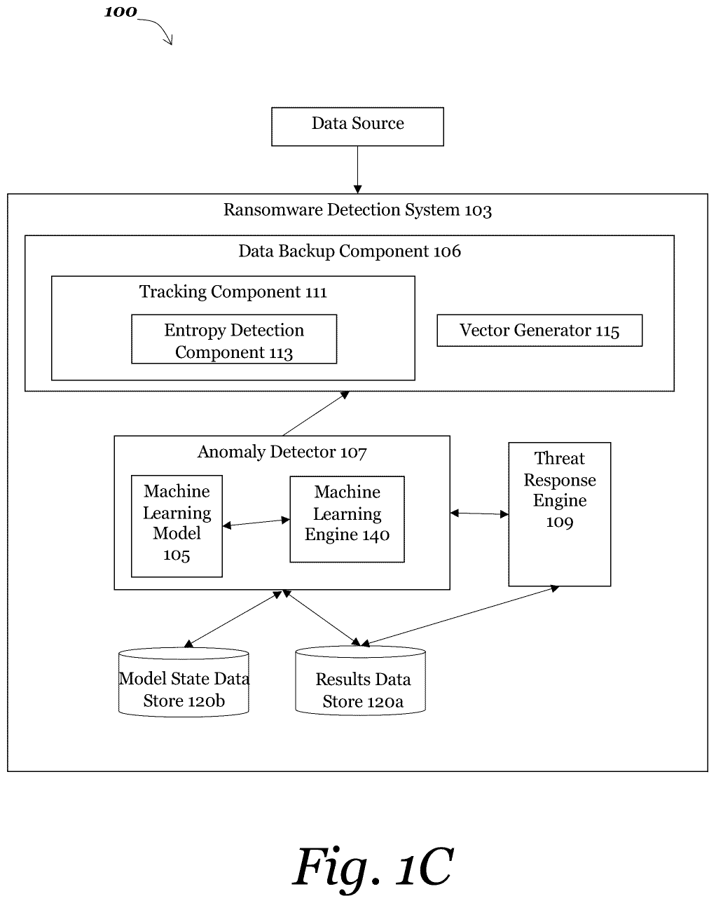

Referring now to FIG. 1A, a block diagram depicts an embodiment of a system 100 for detecting resources having anomalous attributes. The system 100 may be a data protection system 100 including a ransomware detection system 103, executing at least in part on a computing device 106a, and a data backup component 106b. The system 100 may have a composable architecture designed to execute artificial-intelligence (AI)-driven data protection workflows, allowing efficient implementation of fine-grained ransomware detection techniques that would be unfeasible or impossible to implement in conventional systems. The system 100 may include execution of one or more components in a serverless architecture.

In one embodiment, the data protection system 100 includes composable architecture has been purpose-built for executing data protection workflows driven by artificial intelligence (AI), enabling efficient implementation of fine-grained ransomware detection techniques that would be unfeasible or impossible to implement in conventional systems.

The system 100 may include functionality for executing components for backing up data (data backup, as will be understood by those of skill in the art, including processes for making and storing additional copies of data, the copies being stored on the same or different computing devices or components as the computing device(s) or components that store the original version of the data). The data protection system 100 may include functionality for executing components for detecting ransomware, which may be referred to as a ransomware detection system 103 (also referred to herein as a ransomware detection engine 103).

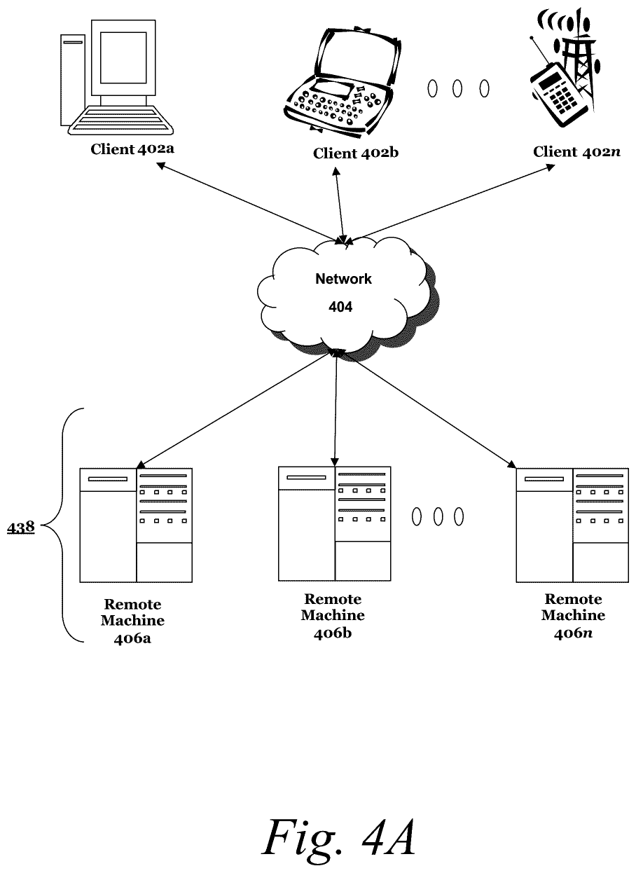

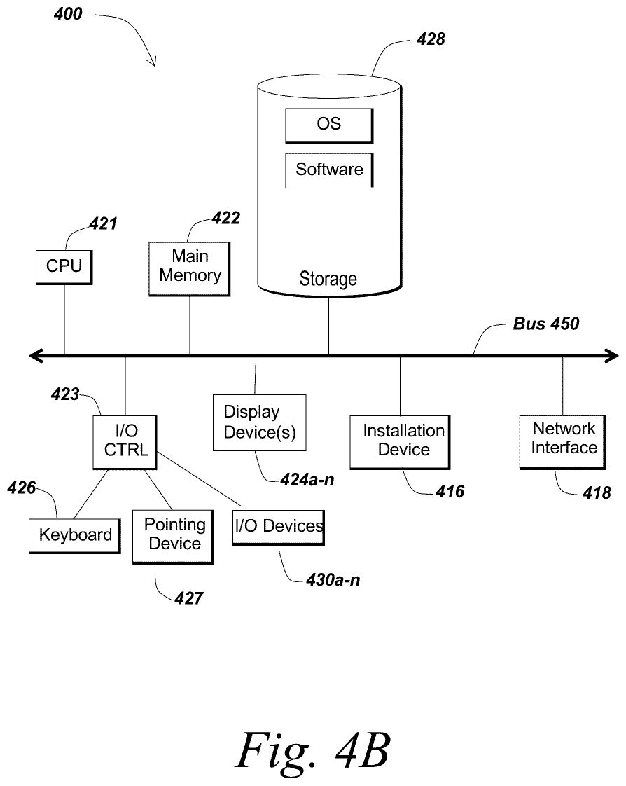

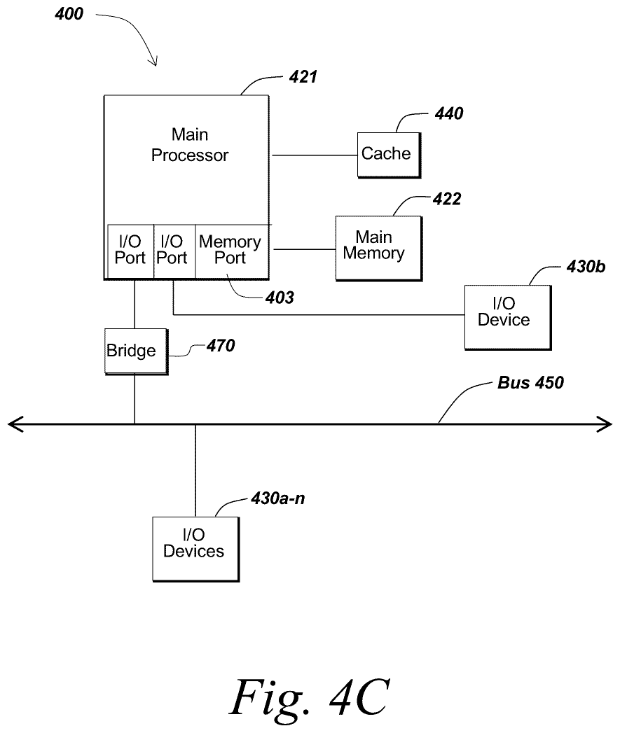

The data backup component 106b may be a computing device executing one or more data backup processes, such as a computing device 400 described in greater detail below in connection with FIGS. 4A-4C. Alternatively, the data backup component 106b may be a component executing on a computing device 106b and executing one or more data backup processes.

The data backup component 106b may provide functionality for executing a process for backing up one or more resources. The data backup component 106b may provide functionality for interacting with one or more Application Programming Interfaces (APIs) to back up received resources. In some embodiments, the data backup component 106b may include or be in communication with a state machine for use in executing one or more backup tasks. The data backup component 106b may execute one or more processes that provide functionality enabling users to search for (e.g., run queries against a data store to search for) and access backed up resources, which may be versioned copies of the resources originally transmitted for backup. The data backup component 106b may provide functionality that is executed by one or more processes that provide functionality enabling users to search for (e.g., run queries against a data store to search for) and access backed up resources, which may be versioned copies of the resources originally transmitted for backup. A state machine may represent the one or more processes.

In some embodiments, the data backup component 106b receives one or more resources for backing up from one or more data sources. Although only one data source and one data backup component 106b are depicted in FIG. 1A, it will be understood by those of skill in the art that there may be a plurality of data backup components 106b and a plurality of data sources in the system 100. Resources may include files, user data, and/or metadata associated with each.

The ransomware detection system 103 may execute functionality for generating at least one machine learning model 105. The ransomware detection system 103 may execute an anomaly detector 107. The ransomware detection system 103 may execute a threat response engine 109.

The ransomware detection system 103 may execute functionality for generating at least one machine learning model 105. The ransomware detection system 103 may execute a machine learning engine component 140. The machine learning engine component 140 may be in communication with or incorporated into, an anomaly detector 107.

The ransomware detection system 103 may execute an anomaly detector 107. In some embodiments, the ransomware detection system 103 generates one or more machine learning models 105 and the anomaly detector 107 utilizes the generated machine learning models 105. In some embodiments, the ransomware detection system 103 generates one or more machine learning models 105 and the anomaly detector 107 communicates with the machine learning engine component 140 to utilize the generated machine learning models 105. The anomaly detector 107 may be a machine learning engine 140. The anomaly detector 107 may be in communication with a machine learning engine 140.

The ransomware detection system 103 may execute a threat response engine 109. The threat response engine 109 may provide functionality for alerting one or more users of a determination that a resource is anomalous. The threat response engine 109 may provide functionality for providing to one or more users an identification of a user associated with the resource determined to be anomalous.

The ransomware detection system 103 may include or be in communication with a data store 120. The data store 120 may be an ODBC-compliant database. For example, the data store 120 may be provided as ORACLE databases, manufactured by Oracle Corporation of Redwood Shores, CA. In other embodiments, the data store 120 may be a Microsoft ACCESS database or a Microsoft SQL server database, manufactured by Microsoft Corporation of Redmond, WA. In other embodiments, the data store 120 may be a SQLite database distributed by Hwaci of Charlotte, NC, or a PostgreSQL database distributed by The PostgreSQL Global Development Group. In still other embodiments, the data store 120 may be a custom-designed database based on an open-source database, such as the MYSQL family of freely available database products distributed by Oracle Corporation of Redwood City, CA. In other embodiments, examples of databases include, without limitation, structured storage (e.g., NoSQL-type databases and BigTable databases), HBase databases distributed by The Apache Software Foundation of Forest Hill, MD, MongoDB databases distributed by 10Gen, Inc., of New York, NY, an AWS DynamoDB distributed by Amazon Web Services and Cassandra databases distributed by The Apache Software Foundation of Forest Hill, MD. In further embodiments, the data store 120 may be any form or type of database.

Although, for ease of discussion, the components described in FIG. 1A, are described as separate modules, it should be understood that this does not restrict the architecture to a particular implementation. For instance, some or all of the components may be encompassed by a single circuit or software function or, alternatively, distributed across a plurality of computing devices.

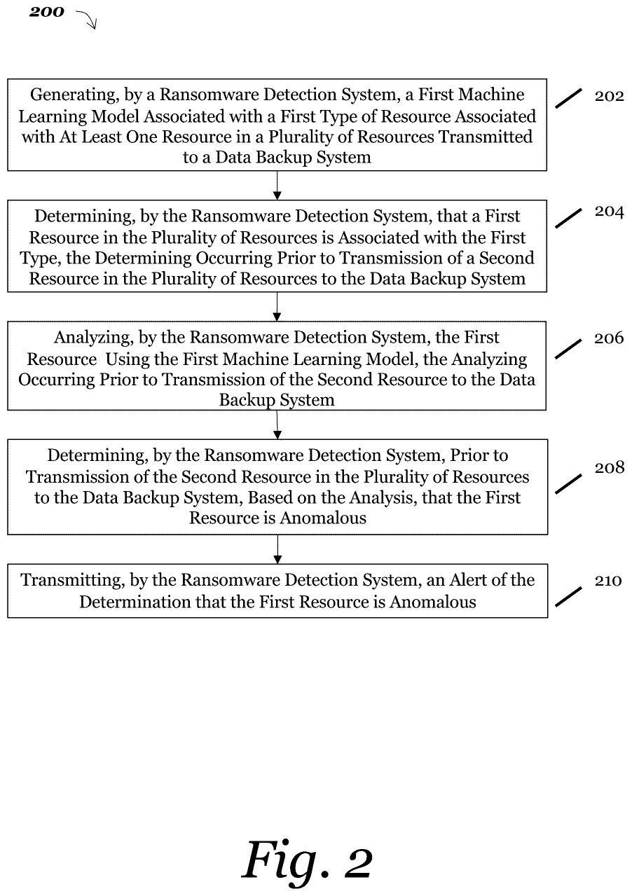

Referring now to FIG. 2, in brief overview, a block diagram depicts one embodiment of a method 200 for detecting, by a ransomware detection engine, via at least one resource-level entropy check during a process for backing up a plurality of resources. The method 200 includes generating, by a ransomware detection system, a first machine learning model associated with a first type of resource associated with at least one resource in a plurality of resources transmitted to a data backup system (202). The method 200 includes determining, by the ransomware detection system, that a first resource in the plurality of resources is associated with the first type, the determining occurring prior to transmission of a second resource in the plurality of resources to the data backup system (204). The method includes analyzing, by the ransomware detection system, using the first machine learning model, the analyzing occurring prior to transmission of the second resource to the data backup system (206). The method includes determining, by the ransomware detection system, prior to transmission of the second resource in the plurality of resources to the data backup system, based on the analysis, that the first resource is anomalous (208). The method includes transmitting, by the ransomware detection system, an alert of the determination that the first resource is anomalous (210). The methods described herein may therefore include generating a machine learning model for each resource. The methods described herein may include analyzing data during a back-up process, e.g., “live” during back-up. The methods and systems described herein may provide functionality for generating and transmitting, to one or more users, one or more alerts of the determination that the identified encrypted resource is anomalous; the alerts may include an identification of one or more users associated with the identified encrypted resource.

Referring now to FIG. 2, in greater detail and in connection with FIG. 1, the method 200 includes generating, by a ransomware detection system, a first machine learning model associated with a first type of resource associated with at least one resource in a plurality of resources transmitted to a data backup system (202). Generating the machine learning model 105 may include training the machine learning model 105. The ransomware detection system 103 may generate the first machine learning model 105 associated with the first type of resource based on a type of user associated with the at least one resource; by way of example, and without limitation, the ransomware detection system 103 may at least one generate machine learning model 105 based on an attribute of a user of the system 100 having at least one resource stored by the data backup device 106b. The ransomware detection system 103 may generate the first machine learning model 105 associated with the first type of resource based on an attribute of the plurality of resources; by way of example, and without limitation, if the resources are backed up from a particular location or via a particular service, the ransomware detection system 103 may use that information in generating the first machine learning model 105. The ransomware detection system 103 may generate the first machine learning model 105 associated with the first type of resource based on an attribute of a computing device transmitting the plurality of resources to the data backup device 106b; by way of example, and without limitation, if the resources to be backed up are associated with a particular type of end-user computing device (or with a user of a particular type), the ransomware detection system 103 may use that information in generating the first machine learning model 105. In some embodiments, by generating at least one machine learning model 105 and training the at least one machine learning model 105 to make inferences about anomalies in, and possible attacks to, specific users, the methods and systems described herein provide improved technology for identifying anomalies and detecting threats.

In some embodiments, the method 200 includes generating at least one machine learning model for an entity associated with the plurality of resources. By way of example, the entity associated with the plurality of resources may be a single user. As another example, the entity associated with the plurality of resources may be an organizational unit. As a further example, the entity associated with the plurality of resources may be an entity hosting the plurality of resources on a data source such as, without limitation, a SharePoint site provided by Microsoft Corporation of Redmond, WA.

The ransomware detection system 103 may generate and/or utilize multivariate observations for unsupervised learning. The ransomware detection system 103 may generate and/or utilize per-user threat detection models. The ransomware detection system 103 may generate and/or utilize ensemble methods. The ransomware detection system 103 may generate and/or utilize continuous learning functionality. The ransomware detection system 103 may provide or integrate with one or more components for providing extended detection and response (XDR) functionality.

The method 200 includes determining, by the ransomware detection system, that a first resource in the plurality of resources is associated with the first type, the determining occurring prior to transmission of a second resource in the plurality of resources to the data backup system (204). The ransomware detection system 103 may access internal metrics to make the determination of the type of the first resource. For example, and without limitation, the ransomware detection system 103 may access metrics relating to byte distribution data, compression data, encryption statistics, file churn metadata, modification time metadata, and extension metadata.

Alternatively, in some embodiments, the ransomware detection system 103 utilizes all available machine learning models in analyzing each of the plurality of resources, without determining a type of each of the plurality of resources. In some embodiments, the ransomware detection system 103 generates a plurality of machine learning models, wherein each of the plurality of machine learning models may be associated with at least one of a plurality of types of anomalies; analyzes each of the plurality of resources utilizing each of the plurality of machine learning models; and determines that a first resource in the plurality of resources is associated with at least one of the plurality of types of anomalies, the analyzing and determining occurring prior to transmission of a second resource in the plurality of resources to the data backup system; the ransomware detection system may generate and transmit an alert of the determination, which may include generating and transmitting an identification of a user associated with the first resource.

The method 200 includes analyzing, by the ransomware detection system, using the first machine learning model, the analyzing occurring prior to transmission of the second resource to the data backup system (206). The anomaly detector 107 may analyze the resource using the machine learning model 105. The anomaly detector 107 may implement a Random Cut Forests (RCFs) machine learning technique to evaluate whether a resource and/or subject associated with the resource is likely to have been impacted by a ransomware attack. The ransomware detection system 103 may execute one or more anomaly detection models 105 to detect ransomware in user environments. Anomaly detection may refer to a family of unsupervised machine learning algorithms that execute functionality to identify one or more norms within a given data set or system and then identify and generate alerts regarding deviations from these norms. The unsupervised nature of these models may address the “cold start” problem—that is, enabling AI-driven ransomware detection without requiring a corpus of pre-aggregated training data or reinforcement learning or continual redeployment of versioned models. The anomaly detection models may be considered “multivariate” because they are designed to process observations which consist of multiple signals. For example, the system may generate one observation for each backed-up file and, by collecting multiple signals for each file, may detect attacks from a wide range of ransomware strains, which is non-trivial. For example, some ransomware strains encrypt the entirety of the file content so that the victim can't salvage any unencrypted content, while others only encrypt a portion of the file content so that they can expedite the attack process. Lockbit falls into the latter category and Splunk cybersecurity researchers observed this strain to be capable of encrypting over 98,000 files, totaling 53 GB, in less than 5 minutes because it only encrypts 4 KB of each file. The system may identify a set of signals which are highly representative of ransomware-encrypted files and feed these inputs to the one or more anomaly detection models. The system may also collect a multivariate observation for each file on every backup. This breaks the industry consensus holding that it was prohibitively inefficient to collect signals at this per-resource level of granularity and frequency.

Therefore, execution of the methods and systems described herein may result in increased efficiency and improved technology for detecting ransomware attacks, including those attacks which are programmed to encrypt only a subset of available data. The method 200 may include identifying a user associated with the first resource having the anomalous attribute. The method 200 may include determining that one or more of the resources associated with the identified user are associated with at least one anomalous attribute. The method 200 may include determining that the resources associated with the identified user are associated with a ransomware attack occurring at or before a time of transmission of the plurality of resources. Similarly, the method 200 may include identifying an organizational unit associated with the first resource having the anomalous attribute. The method 200 may include determining that one or more of the resources associated with the identified organizational unit are associated with at least one anomalous attribute. The method 200 may include determining that the resources associated with the identified organizational unit are associated with a ransomware attack occurring at or before a time of transmission of the plurality of resources.

The methods and systems described herein may therefore implement per-user threat detection models. As an example of one embodiment of the method 200, and without limitation, an end user may be a firm that has 75 employees, of which 5 are executives; there is a targeted ransomware attack against just the executive team that works with critical client and business data. If multivariate observations were to be collected from all 75 users and fed into a single anomaly detection model, the performance would be underwhelming because the patterns in file-related activity differ greatly between the 75 employees. This skews the aggregate model's perception of “normal” such that it's less likely to raise an alarm. Instead, the system may increase a level of accuracy in inference results by implementing separate anomaly detection models for each user, where each model is trained on the file-related activity trends which are specific for that user. By having a model assigned to a specific user, each model is trained only on data collected from that assigned user's backups. As a result, the threat inferences are tailored to that user. The same technique is also applied to other distinct resources, such as, without limitation, individual SharePoint sites, that contain data at risk of ransomware. In one embodiment, the ransomware detection system 103 maintains multiple dedicated models for each subject protected by the backup service-including by way of example and without limitation, “organizational units” (such as, a user or SharePoint site—that transmits resources for backup and which may be affected by ransomware. As a result, the ransomware detection system 103 may implicitly separate the models for different user profiles or different locations or other attributes of the resources, especially those which may have different file access patterns.

Even though the variance in observations may be greatly reduced by resource-scoped models and/or subject-scoped models, trends in file-related activity for a resource and/or subject may evolve over time. For example, new file access patterns may begin when a user changes roles or onboards to a new project. To account for this, therefore, the system 100 may use machine learning models 105 that support continuous learning (also referred to as “online learning”) so that the ransomware detection system 103 may automatically prune stale observations and replace those observations with fresh observations based on the more recent data patterns. This is different from traditional machine learning models where training and inference are discrete processes and, once a model is deployed it remains static and unable to learn from new observations, resulting in systems that cannot adapt as user behaviors change, without involving explicit re-training and re-deployment of the static model, which may involve prohibitively expensive technological costs. Even if conventional models take in data and generate an improvement that may be deployed in a subsequent version of the entire system, end-users would not benefit from such a system until that subsequent version is released (if ever) instead of from the time a new behavior pattern emerges. It may be helpful to compare these model architectures through the lens of software deployment frameworks (continuous deployments vs. versioned deployments)—with the continuous deployment framework, customers benefit from improvements and fixes in real time. The ability to adapt in real-time to changes in file-related activity patterns may result in an improved technological solution to the problem of detecting for detecting ransomware. In some embodiments, the continuous learning capability may be refined so that the system 100 is still able to detect ransomware attacks that encrypt data at a slower rate. Traditionally, ransomware attacks try to encrypt data as quickly as possible, but this slow-moving approach may be used to avoid other ransomware detection alarms based on resource consumption (e.g., CPU utilization or network I/O).

In some embodiments, the methods and systems described herein may leverage extended detection response (XDR) functionality. For example, the system may integrate or otherwise communicate with third-party services to identify ransomware-related signals and may seamlessly integrate relevant data into the user interfaces of the system so that users may see all relevant data (including, e.g., alerts) in a single interface. The XDR integration also allows the system 100 to benefit from detected attacks impacting other parts of a user's IT infrastructure (e.g., employee laptops or cloud-based virtual machines). Apart from being able to leverage these signals in the machine learning models used by the system, such integration also allows the system 100 to trigger proactive backups to capture clean data before the attack spreads further.

The method 200 includes determining, by the ransomware detection system, prior to transmission of the second resource in the plurality of resources to the data backup system, based on the analysis, that the first resource is anomalous (208). The ransomware detection system 103 may determine that the first resource has been encrypted in a manner that is anomalous in comparison with other resources in the plurality of resources. In some embodiments, the ransomware detection system 103 analyzes one or more resource-level attributes to determine whether a level of anomaly satisfies a threshold level of anomaly; the threshold level of anomaly may be determined by comparing the resource-level attribute determined for the first resource with historical attributes identified for the same resource and/or the same type of resource and/or the same user associated with the resource and/or the same organizational unit or other entity associated with the user associated with the resource.

The ransomware detection system 103 may determine that the first resource has been compressed in a manner that is anomalous in comparison with other resources in the plurality of resources. In some embodiments, the ransomware detection system 103 generates an entropy score associated with the first resource and determines that the entropy score associated with the first resource exceeds a threshold level of entropy scores. The ransomware detection system 103 may determine that the first resource has been encrypted or compressed in a manner that results in a level of entropy that satisfies a threshold level of similarity to levels of entropy associated with resources known to be anomalous. The ransomware detection system 103 may determine that the first resource includes ransomware.

In some embodiments, the method 200 includes determining, by the ransomware detection system 103 that a second resource in the plurality of resources is associated with the first type, the determining occurring prior to transmission of a third resource in the plurality of resources to the data backup system 106b; analyzing, prior to transmission of a third resource in the plurality of resources to the data backup system 106b, using the first machine learning model, the second resource; and determining, prior to transmission of the third resource in the plurality of resources to the data backup system 106b, that the first resource and the second resource are associated with a type of anomalous behavior. In such embodiments, the system 100 may determineduring transmission of additional resources to the data backup system 106b—that a plurality of resources being transmitted to the data backup system 106b exhibit anomalous behavior.

In some embodiments, all machine learning models 105 in a plurality of machine learning models are utilized in analyzing all of the resources that are transmitted to the data backup system, regardless of the type of resource. In other embodiments, machine learning models are only utilized in analyzing resources of a particular type.

By training and utilizing machine learning models at a more granular level than conventional technologies can support (e.g., at a per resource level), the ransomware detection system 103 is able to detect anomalies more quickly. Providing earlier detection of anomalies enables the system to generate and transmit alerts notifying users of the anomalies and to take other steps that may mitigate the impact of the anomalies.

By additionally implementing “ensemble methods” for each resource, each inference result published to the customer is a combination of results from many models. Each model in the ensemble analyzes the likelihood of threat for a specific ransomware attack profile. For instance, certain models 105 may be refined to account for the speed at which data is encrypted (remember the Lockbit example from above). Meanwhile, other models 105 may be optimized to detect ransomware attacks based on the encryption approach-some strains encrypt the data in-place while other strains delete the original file and replace it with a new file containing the encrypted content. Therefore, the system 100 may encode domain-specific knowledge into the one or more machine learning models 105 used herein and/or may apply a plurality of such machine learning models 105 (for example, either in parallel or in serial) to detect anomalies. In some embodiments, the ransomware detection system 103 may identify and apply multiple machine learning models 105 per user and/or per site to provide improved functionality for identifying different types of anomalies (and therefore, different types of attacks). The anomaly detector 107 may execute a cost-efficient architecture that supports online learning on a per resource level of granularity, and/or on a per user or site level of granularity. By designing the ransomware detection feature in this way, the system 100 may generate threat insights tailored to each protected resource and may leverage each of the distinct ransomware attack profiles during analysis and detection of anomalies.

Therefore, in some embodiments, the method 200 includes generating, by the ransomware detection system 103, a second machine learning model 105b (not shown) associated with a second type of resource associated with at least one resource in the plurality of resources; determining, by the ransomware detection system 103, that the first resource is associated with the second type; and analyzing, by the ransomware detection system 103, using the second generated machine learning model, the first resource. In such embodiments, execution of the method 200 may result in use of a plurality of machine learning models to analyze one (or more) resources to provide improved technology for detecting anomalies.

The method 200 includes transmitting, by the ransomware detection system, an alert of the determination that the first resource is anomalous (210). The threat response engine 109 may execute an incident reporting process to generate and transmit the alert. The threat response engine 109 may store data associated with the determination of the resource anomaly in a threat database.

Referring now to FIG. 1B, a block diagram depicts one embodiment of a user interface generated by the treat response engine 109 depicting a level of effectiveness of one embodiment of the ransomware detection engine against the Bad Rabbit ransomware strain on a variety of different file types and file sizes; the dotted line represents the threshold which separates ransomware-encrypted files from non-ransomware-encrypted files.

Referring back to FIG. 2, in some embodiments, the system 100 provides functionality for ensuring that data from one user or set of users is not shared with other users or sets of users; for example, the system 100 may ensure that data that is backed up to one or more data backup devices 106b is not accessible to other tenants whose data is backed up within the system 100. As indicated above, the ransomware detection system 103 may execute one or more machine learning models 105 (directly or, via the machine learning engine 140, indirectly). Scoping each model 105 to a specific resource may enhance tenant isolation and provide increased data security—at least in part because observations from resources belonging to different tenants need not be pooled together to train the one or more machine learning models 105.

The ransomware threat detection system 103 and the data protection system 100 generally may therefore provide an increased level of effectiveness against a number of ransomware strains.

Referring now to FIG. 1C, a block diagram depicts another embodiment of a system 100 for detecting resources having anomalous attributes. As depicted in FIG. 1C, the ransomware detection system 103 may execute a tracking component 111, which in turn may execute an entropy detection component 113. The tracking component 111 in the ransomware detection system tracks an attribute of a first of a plurality of resources transmitted to a data backup system. The tracking component 111 may generate a plurality of metrics associated with the first of the plurality of resources. The entropy detection component 113 determines a level of entropy for the first of the plurality of resources, based on the attribute and/or at least one of the plurality of metrics. A vector generator 115 may determine that the level of entropy for the first of the plurality of resources exceeds a threshold level of entropy, wherein the determining of the level of entropy occurs prior to the transmission of a second of the plurality of resources to the data backup system. The vector generator 115 may determine that at least one of the plurality of metrics is anomalous. The anomaly detector 107 may utilize at least one machine learning model to determine that at least one feature in the vector (including, without limitation, the level of entropy) is associated with an anomalous attribute, wherein the determining of the association occurs prior to the transmission of a second of the plurality of resources to the data backup system. The data store 120 may include or be in communication with an incident database storing an identification of a user associated with the first of the plurality of resources.

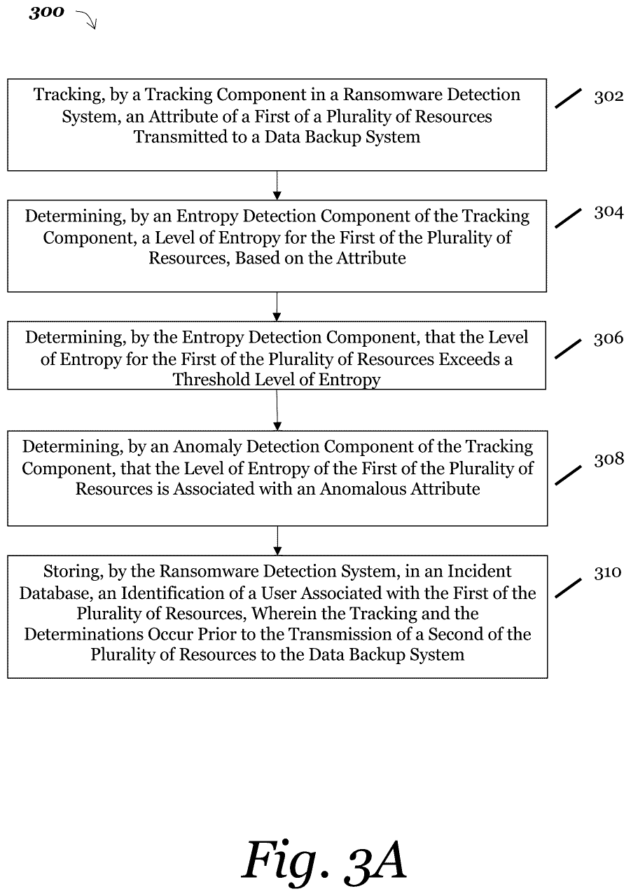

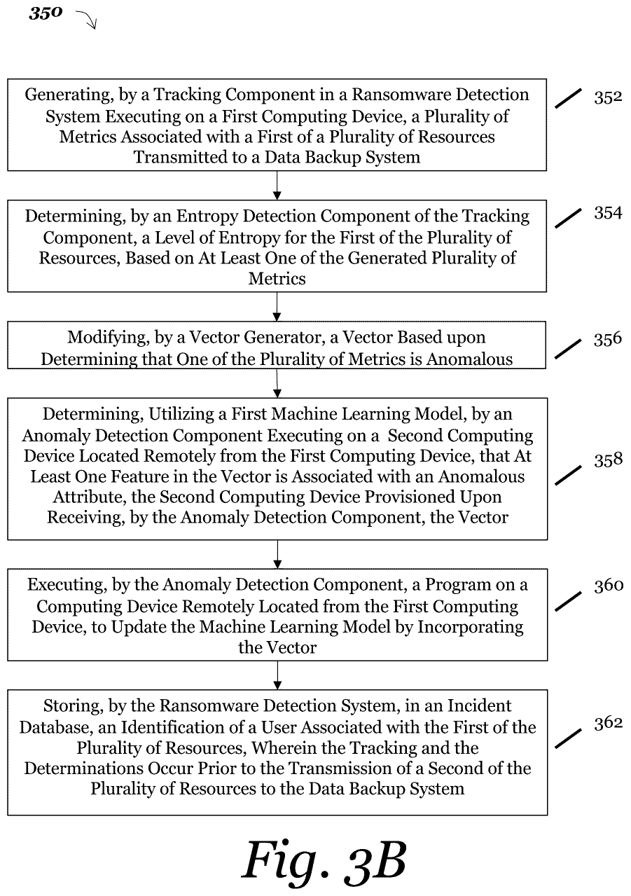

Referring now to FIG. 3A, in brief overview, a flow diagram depicts one embodiment of a method 300 detecting, by a ransomware detection engine, via at least one resource-level entropy check during a process for backing up a plurality of resources, a resource in the plurality of resources having an anomalous attribute. The method 300 includes tracking, by the tracking component in a ransomware detection system, an attribute of a first of a plurality of resources transmitted to a data backup system (302). The method 300 includes determining, by an entropy detection component of the tracking component, a level of entropy for the first of the plurality of resources, based on the attribute (304). The method 300 includes determining, by entropy detection component, that the level of entropy for the first of the plurality of resources exceeds a threshold level of entropy (306). The method 300 includes determining, by an anomaly detection component of the tracking component, that the level of entropy of the first of the plurality of resources is associated with an anomalous attribute (308). The method 300 includes storing, by the ransomware detection system, in an incident database, an identification of the first of the plurality of resources, the tracking and determining steps occurring prior to the transmission of a second of the plurality of resources to the data backup system (310).

Referring now to FIG. 3A, in greater detail and in connection with FIGS. 1A-1C and FIG. 2, the method 300 includes tracking, by the tracking component in a ransomware detection system, an attribute of a first of a plurality of resources transmitted to a data backup system (302). The tracking component 111 may determine the attribute. The tracking component 111 may determine a byte distribution attribute of the first of the plurality of resources. The tracking component 111 may track byte distribution as data (e.g., the plurality of resources) is streamed into the data backup system 106b. By tracking byte distribution as data is streamed into a data backup system 106b, execution of the methods described herein may increase efficiency by eliminating or substantially eliminating additional queries to (and incurring additional response times from) the data backup system 106b.

The method 300 includes determining, by an entropy detection component of the tracking component, a level of entropy for the first of the plurality of resources, based on the attribute (304). The entropy detection component 113 may determine the level of entropy, based on the attribute. The tracking component 111 may execute the entropy detection component 113 subsequent to tracking at least one byte distribution attribute. When the attribute is a byte distribution attribute, the entropy detection component 113 may analyze the byte distribution attribute and determine the level of entropy based on the analyzing of the byte distribution attribute.

The method 300 includes determining, by entropy detection component, that the level of entropy for the first of the plurality of resources exceeds a threshold level of entropy (306). In one embodiment, the tracking component 111 may execute a statistical test to determine if an observed distribution is statistically similar to an expected distribution. As an example, in the case of perfectly random data stored on a file system and streamed into a data backup system, the entropy detection component 113 would predict a substantially equal occurrence of each byte value; in the case of a crypto-ransomware detection, where the files are encrypted, using equal frequencies of byte values for expected distribution and executing the entropy detection component 113 allows the tracking component 111 to determine if there is a similar or substantially equal frequency of byte values between the expected distribution and the observed distribution. Quantifying a level of entropy of a file (or other resource) is valuable because the likelihood of a file being encrypted by ransomware is highly correlated to the entropy of the file's bytes. The method 300 may further include determining a threshold level of entropy to associate with an output value less likely to be correlated with ransomware attacks.

As indicated above, the ransomware detection system 103 may execute one or more machine learning models 105 (directly or, via the machine learning engine 140, indirectly) to determine whether a resource has an anomalous attribute. For example, in some embodiments, the ransomware detection system 103 maintains multiple models for each resource that is analyzed for ransomware. Scoping each model 105 to a specific resource increases model accuracy because the scope of the inference matches the scope of the observations/training data. Maintaining multiple models 105 for a single resource means that the ransomware detection system 103 can detect multiple types of ransomware attack profiles, which is important since ransomware strains can rely on different methods for encrypting files. For example, ransomware approaches can use an “in-place encryption” or “delete-and-replace encryption” approach, but strains also differ in the speed at which they encrypt the data.

The method 300 includes determining, by an anomaly detection component of the tracking component, that the level of entropy of the first of the plurality of resources is associated with an anomalous attribute (308).

The method 300 includes storing, by the ransomware detection system, in an incident database, an identification of the first of the plurality of resources, the tracking and determining steps occurring prior to the transmission of a second of the plurality of resources to the data backup system (310).

Therefore, a method as described herein may calculate a level of entropy for each file in a system for backing up files, rather than needing to sample a subset of files; each model 105 may be trained on observations which are scoped to a specific resource and the ransomware detection system 103 may maintain and apply ensemble methods for each resource.

To prevent false-positive inferences from reaching customers, the system may optionally include a layer of human oversight before alerting customers—if/when the tracking component 111 believes a resource is likely a target of a ransomware attack, the system may publish the inference information and alert an on-call operator to manually review the incident. However, in the case of a true-positive inference result, the need for human intervention may delay the reporting of the ransomware incident. To address this, the method may include, instead of or in addition to the human oversight, executing a modified version of the tracking component so that the entropy score for each file is compared to entropy scores for files of same type (extension) and file size, reducing a level of likelihood that the system will output a false positive. Executing the method in such an embodiment would include the additional steps of: aggregating metadata for each backed up file (or resource) such as without limitation file size, extension, and entropy score, bucketing the metadata by file size and file extension, pre-calculating the mean, standard deviation, and number of observations in each bucket; providing access to an interface (e.g., API) that allows clients to query and use the machine learning model 105. A user interface may tell a user how likely it is that a file with a given size, extension, and entropy score is encrypted by ransomware. The machine learning model 105 may take a size and extension for each API request and calculate an entropy score when compared to entropy scores for files in the same extension+size bucket. The ransomware inference pipeline may use the aforementioned API. For each file backed up, the method may include determining the entropy score and marking the file suspicious of ransomware encryption if the entropy score is less than a threshold score (e.g., without limitation, −2.5).

Referring now to FIG. 3B, in brief overview, a flow diagram depicts an embodiment of a method 350 for detecting, by a ransomware detection system executing a serverless application on a computing device remote from the ransomware detection system, via at least one resource-level entropy check during a process for transmitting a plurality of resource to a data backup system, a resource in the plurality of resources having an anomalous attribute. The method 350 may include generating, by a tracking component in a ransomware detection system executing on a first computing device, a plurality of metrics associated with a first of a plurality of resources transmitted to a data backup system (352). The method 350 may include determining, by an entropy detection component of the tracking component, a level of entropy for the first of the plurality of resources, based on at least one of the generated plurality of metrics (354). The method 350 may include modifying, by a vector generator, a vector based upon determining that one of the plurality of metrics is anomalous (356). The method 350 may include determining, utilizing a first machine learning model, by an anomaly detection component executing on a second computing device located remotely from the first computing device, that at least one feature in the vector is associated with an anomalous attribute, the second computing device provisioned upon receiving, by the anomaly detection component, the vector (358). The method 350 may include executing, by the anomaly detection component, a program on a computing device remotely located from the first computing device, to update the machine learning model by incorporating the vector (360). The method 350 may include storing, by the ransomware detection system, in an incident database, an identification of a user associated with the first of the plurality of resources, wherein generating the plurality of metrics, determining the level of entropy, modifying the vector, and determining that the feature in the vector is associated with an anomalous attribute occur prior to the transmission of a second of the plurality of resources to the data backup system (362).

In one embodiment, the method 350 includes executing a state machine. As will be understood by those of skill in the art, a state machine, also referred to as a finite state machine, may be a component that receives at least one input and, based on the input, determines what “state” the process of executing the method is in, and dynamically determines an appropriate transition to the next state. As will be understood by those of ordinary skill in the art, a state machine may be in one state at a given time and may change from one state to another in response to one or more external inputs. Each state may include one or more instructions that the state machine may provide to other components in the system 100 for execution. The data backup component 106 may include a state machine. The state machine may utilize an API to retrieve data or execute a query. The method 350 may execute the state machine and the state machine may utilize an API to request a transmission of resources for backup from a data source (for example, and without limitation, utilizing an API such as the GRAPH API provided by Microsoft Corporation of Redmond, WA).

Referring now to FIG. 3B, in greater detail and in connection with FIGS. 1A-3A, the method 350 includes generating, by a tracking component in a ransomware detection system executing on a first computing device, a plurality of metrics associated with a first of a plurality of resources transmitted to a data backup system (352). The data backup component 106 may execute, via the state machine, the tracking component 111 to analyze data received responsive to an API call and passed through the ransomware detection system 103 to be backed up. The tracking component 111 may read one or more bytes as the bytes are streamed responsive to the API call. The tracking component 111 may generate one or more statistics associated with one of the plurality of resources being backed up. The tracking component 111 may generate a byte distribution statistic associated with one of the plurality of resources being backed up. Byte distribution may be used in determining a level of entropy (or randomness) of the bytes in a particular resource. As an example, bytes that have been encrypted may have a more uniform level of byte distribution. As another example, the tracking component 111 may identify data associated with a file extension of a file in the plurality of resources. As another example, the tracking component 111 may identify data associated with one or more header bytes in a header of a file in the plurality of resources.

The method 350 includes determining, by an entropy detection component of the tracking component, a level of entropy for the first of the plurality of resources, based on at least one of the generated plurality of metrics (354). The entropy detection component 113 may determine the level of entropy as described above in connection with FIG. 3A (304).

The method 350 includes modifying, by a vector generator, a vector based upon determining that one of the plurality of metrics is anomalous (356). The method 350 may include executing a vector generator 115 to generate and/or modify a vector representing a feature set. The vector may be a file-level vector. The vector may be an aggregate of a plurality of file-level vectors, resulting in a summary vector that aggregates the values in the file-level vectors into a single vector; by way of example, the vector generator 115 may aggregate the values in the file-level vectors for each of a subset of the plurality of resources associated with a user, generating a per-user vector. The aggregate vector may be used in determining whether a resource is anomalous. For example, in some embodiments, the ransomware detection system 103 identifies one resource to be “suspicious” but will not determine this to be associated with a Ransomware Incident if, for example, a user with 10,000 files has a single “suspicious” file. The system allows operators to define a “blast radius” which may be an absolute number or percentage of resources belonging to an individual user that must be considered “suspicious” in order to constitute a Ransomware Incident.

The vector generator 115 may determine that one of the plurality of metrics is anomalous by analyzing the metric. By way of example, the vector generator 115 may determine that the generated entropy score exceeds a predetermined threshold level of acceptable entropy scores. As another example, the vector generator 115 may determine that a metric in the plurality of metrics includes a plurality of header bytes having an alphanumeric pattern that differs from a specified patterns of non-anomalous header bytes by a threshold amount of difference. As another example, the vector generator 115 may determine that a metric in the plurality of metrics includes a plurality of alphanumeric values in a file extension that has a threshold level of similarity with an alphanumeric pattern associated with anomalous resources.

The method 350 includes determining, utilizing a first machine learning model, by an anomaly detection component executing on a second computing device located remotely from the first computing device, that at least one feature in the vector is associated with an anomalous attribute, the second computing device provisioned upon receiving, by the anomaly detection component, the vector (358).

The method 350 includes executing, by the anomaly detection component, a program on a computing device remotely located from the first computing device, to update the machine learning model by incorporating the vector (360). As indicated above, system 100 may support “online” learning. The ransomware detection system 103 may be configured to execute the anomaly detector 107 in a manner supports online learning. Unlike conventional machine learning models where training and inference are typically discrete processes (and once a model is deployed, it cannot learn from new observations and can only make inferences based upon those observations), an online learning model may learn during execution of the model, which benefits both end users during execution and may reduce a level of operational load. By enabling the components of the ransomware detection system 103 to collect data and provide the data as input to one or more models 105 during execution, the ransomware detection system 103 enables online learning. The ransomware detection system 103 may be configured to efficiently prune observations, allowing the anomaly detector 107 to replace older observations with observations generated based on newer data, ensuring that a cost of storing a serialized state of the anomaly detector 107 is a fixed cost instead of one that grows as new observations are generated and stored.

The system 100 may be configured to deploy a cost-efficient model architecture. Observations (e.g., vectors) may be published (e.g., for incorporation into an online learning process) when a backup is run for a resource which, as an example and without limitation, may result in three observations for each resource per day; such a workload is well-suited for a serverless architecture. When a new observation is published (e.g., when the plurality of metrics is generated by the tracking component 111 and/or when the feature vector is generated and/or modified by the vector generator 115), the ransomware detection system 103 may execute a command to instantiate, on a remote computing device, a process for updating a machine learning model 105. By way of example, and without limitation, the ransomware detection system 103 may store a program for updating the machine learning model 105 on the remote computing device and instruct the remote computing device to execute the program upon transmission of data (such as the vector-based observations) to the remote computing device or to a second remote computing device associated with the remote computing device storing the program. The remote computing devices may be maintained by an entity maintaining the ransomware detection system 103 or by a third-party entity (e.g., a cloud-based service provider). The ransomware detection system 103 may generate and transmit to the computing device storing the program for updating the machine learning model 105 a query for the most recent version of a state of a state machine associated with the machine learning model 105. Based upon the response received from the program for updating the machine learning model 105, the ransomware detection system 103 may update the anomaly detector 107. The ransomware detection system 103 may publish an inference result generated by the anomaly detector 107 based on the observations and save a new version of the state of the machine learning model 105 state. Such an implement allows for falling back to older versions of the machine learning model 105, if needed.

The method 350 includes storing, by the ransomware detection system, in an incident database, an identification of a user associated with the first of the plurality of resources, wherein generating the plurality of metrics, determining the level of entropy, modifying the vector, and determining that the feature in the vector is associated with an anomalous attribute occur prior to the transmission of a second of the plurality of resources to the data backup system (362). The ransomware detection system 103 may store an outcome of the execution of the method in a first data store 120a.

The ransomware detection system 103 may store one or more versions of the serialized state of the model in a model state data base 120b. The ransomware detection system 103 may execute functionality enabling querying for and accessing a particular version of the serialized state and enabling reconstruction of the model using the accessed version of the serialized state. Upon generation of an inference using the reconstruction of the model, the ransomware detection system 103 may update the state of the reconstruction of the model to incorporate a vector underlying the generated inference and then store the serialized state of the reconstruction of the model in the model state data base 120b. The method 350 may further include storing a state of the machine learning model 105. The state of the machine learning model 105 may include a plurality of vectors (e.g., feature set vectors at either the file level or the aggregate per-user level or both). The method 350 may include storing the state of the machine learning model after the anomaly detector 107 completes execution and before the anomaly detector 107 is uninstantiated. By way of example, the state of the machine learning model 105 may be stored as a JSON file in the model state data base 120b. The method 350 may further include functionality for restoring a state of the machine learning model 105. Therefore, the method 350 may include serializing a state of machine learning model to persistent storage.

Therefore, the methods and systems described herein provide for execution of a data protection system includes composable architecture purpose-built for AI-driven data protection workflows, allowing efficient implementation of fine-grained ransomware detection techniques that would be unfeasible or impossible to implement in conventional systems. The methods and systems described herein leverage multivariate observations (independent signals from ensemble methods used to detect different attack patterns, such as full vs. partial encryption), continuous learning (machine learning models using online learning to continuously adapt to changing user behaviors), XDR integration (ability to use third-party signals as additional input to machine learning models and as triggers for proactive backups), and early detection via per-resource analysis at the user level and file level detection of ransomware (e.g., file-level entropy analysis), to provide an improved technical system that provides both data protection (e.g., data backup) and ransomware detection.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIGS. 2, 3A, and 3B.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

Although terms such as “optimize” and “optimal” may be used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 4A, 4B, and 4C, block diagrams depict additional detail regarding computing devices that may be modified to execute novel, non-obvious functionality for implementing the methods and systems described above.

Referring now to FIG. 4A, an embodiment of a network environment is depicted. In brief overview, the network environment comprises one or more clients 402a-402n (also generally referred to as local machine(s) 402, client(s) 402, client node(s) 402, client machine(s) 402, client computer(s) 402, client device(s) 402, computing device(s) 402, endpoint(s) 402, or endpoint node(s) 402) in communication with one or more remote machines 406a-406n (also generally referred to as server(s) 406 or computing device(s) 406) via one or more networks 404. Any communication disclosed herein, such as communication shown in FIG. 1A, may occur over any embodiment of the network environment depicted in FIG. 4A.

Although FIG. 4A shows a network 404 between the clients 402 and the remote machines 406, the clients 402 and the remote machines 406 may be on the same network 404. The network 404 can be a local area network (LAN), such as a company Intranet, a metropolitan area network (MAN), or a wide area network (WAN), such as the Internet or the World Wide Web. In some embodiments, there are multiple networks 404 between the clients 402 and the remote machines 406. In one of these embodiments, a network 404′ (not shown) may be a private network and a network 404 may be a public network. In another of these embodiments, a network 404 may be a private network and a network 404′ a public network. In still another embodiment, networks 404 and 404′ may both be private networks. In yet another embodiment, networks 404 and 404′ may both be public networks.

The network 404 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, a wireline network, an Ethernet, a virtual private network (VPN), a software-defined network (SDN), a network within the cloud such as AWS VPC (Virtual Private Cloud) network or Azure Virtual Network (VNet), and a RDMA (Remote Direct Memory Access) network. In some embodiments, the network 404 may comprise a wireless link, such as an infrared channel or satellite band. The topology of the network 404 may be a bus, star, or ring network topology. The network 404 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 402 and a remote machine 406 (referred to generally as computing devices 400 or as machines 400) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 402 may execute, operate or otherwise provide an application, which can be any type and/or form of software, program, or executable instructions, including, without limitation, any type and/or form of web browser, web-based client, client-server application, an ActiveX control, a JAVA applet, a webserver, a database, an HPC (high performance computing) application, a data processing application, or any other type and/or form of executable instructions capable of executing on client 402.

In one embodiment, a computing device 406 provides functionality of a web server. The web server may be any type of web server, including web servers that are open-source web servers, web servers that execute proprietary software, and cloud-based web servers where a third party hosts the hardware executing the functionality of the web server. In some embodiments, a web server 406 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the ORACLE WEBLOGIC products provided by Oracle Corporation of Redwood Shores, CA.

In some embodiments, the system may include multiple, logically-grouped remote machines 406. In one of these embodiments, the logical group of remote machines may be referred to as a server farm 438. In another of these embodiments, the server farm 438 may be administered as a single entity.

FIGS. 4B and 4C depict block diagrams of a computing device 400 useful for practicing an embodiment of the client 402 or a remote machine 406. As shown in FIGS. 4B and 4C, each computing device 400 includes a central processing unit 421, and a main memory unit 422. As shown in FIG. 4B, a computing device 400 may include a storage device 428, an installation device 416, a network interface 418, an I/O controller 423, display devices 424a-n, a keyboard 426, a pointing device 427, such as a mouse, and one or more other I/O devices 430a-n. The storage device 428 may include, without limitation, an operating system and software. As shown in FIG. 4C, each computing device 400 may also include additional optional elements, such as a memory port 403, a bridge 470, one or more input/output devices 430a-n (generally referred to using reference numeral 430), and a cache memory 440 in communication with the central processing unit 821.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include RISC-V processors, SPARC processors, ARM processors, processors used to build UNIX/LINUX “white” boxes, and processors for mobile devices. The computing device 400 may be based on any of these processors, or any other processor capable of operating as described herein.

Main memory unit 422 may be one or more memory chips capable of storing data and allowing any storage location to be directly accessed by the microprocessor 421. The main memory 422 may be based on any available memory chips capable of operating as described herein. In the embodiment shown in FIG. 4B, the processor 421 communicates with main memory 422 via a system bus 450. FIG. 4C depicts an embodiment of a computing device 400 in which the processor communicates directly with main memory 422 via a memory port 403. FIG. 4C also depicts an embodiment in which the main processor 421 communicates directly with cache memory 440 via a secondary bus, sometimes referred to as a backside bus. In other embodiments, the main processor 421 communicates with cache memory 440 using the system bus 450.

In the embodiment shown in FIG. 4B, the processor 421 communicates with various I/O devices 430 via a local system bus 450. Various buses may be used to connect the central processing unit 421 to any of the I/O devices 430, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display device 424, the processor 421 may use an Advanced Graphics Port (AGP) to communicate with the display device 424. FIG. 4C depicts an embodiment of a computing device 400 in which the main processor 421 also communicates directly with an I/O device 430b via, for example, HYPERTRANSPORT, RAPIDIO, or INFINIBAND communications technology.

One or more of a wide variety of I/O devices 430a-n may be present in or connected to the computing device 400, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 423 as shown in FIG. 4B. Furthermore, an I/O device may also provide storage and/or an installation medium 416 for the computing device 400. In some embodiments, the computing device 400 may provide USB connections (not shown) to receive handheld USB storage devices such as the USB Flash Drive line of devices manufactured by Twintech Industry, Inc. of Los Alamitos, CA.

Referring still to FIG. 4B, the computing device 400 may support any suitable installation device 416, such as hardware for receiving and interacting with removable storage; e.g., disk drives of any type, CD drives of any type, DVD drives, tape drives of various formats, USB devices, external hard drives, or any other device suitable for installing software and programs. In some embodiments, the computing device 400 may provide functionality for installing software over a network 404. The computing device 400 may further comprise a storage device, such as one or more hard disk drives or redundant arrays of independent disks, for storing an operating system and other software. Alternatively, the computing device 400 may rely on memory chips for storage instead of hard disks.

Furthermore, the computing device 400 may include a network interface 418 to interface to the network 404 through a variety of connections including, but not limited to, standard telephone lines, LAN or WAN links (e.g., 802.11, T1, T3, 56 kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 400 communicates with other computing devices 400′ via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 418 may comprise a built-in network adapter, network interface card, PCMCIA network card, card bus network adapter, wireless network adapter, USB network adapter, modem, or any other device suitable for interfacing the computing device 400 to any type of network capable of communication and performing the operations described herein.

In further embodiments, an I/O device 430 may be a bridge between the system bus 450 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a Serial Plus bus, a SCI/LAMP bus, a Fibre Channel bus, or a Serial Attached small computer system interface bus.

A computing device 400 of the sort depicted in FIGS. 4B and 4C typically operates under the control of operating systems, which control scheduling of tasks and access to system resources. The computing device 400 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 7, WINDOWS 8, WINDOWS VISTA, WINDOWS 10, and WINDOWS 11 all of which are manufactured by Microsoft Corporation of Redmond, WA; MAC OS manufactured by Apple Inc. of Cupertino, CA; OS/2 manufactured by International Business Machines of Armonk, NY; Red Hat Enterprise Linux, a Linux-variant operating system distributed by Red Hat, Inc., of Raleigh, NC; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

Having described certain embodiments of methods and systems for detecting resources having anomalous attributes, it will be apparent to one of skill in the art that other embodiments incorporating the concepts of the disclosure may be used. Therefore, the disclosure should not be limited to certain embodiments, but rather should only be limited by the spirit and scope of the following claims.

What is claimed is:

1. A method for detecting, by a ransomware detection system, via at least one resource-level entropy check during a process for transmitting a plurality of resource to a data backup system, a resource in the plurality of resources having an anomalous attribute, the method comprising:
(A) generating, by a ransomware detection system, a first machine learning model associated with a first type of resource associated with at least one resource in a plurality of resources transmitted to a data backup system;
(B) determining, by the ransomware detection system, that a first resource in the plurality of resources is associated with the first type, the determining occurring prior to transmission of a second resource in the plurality of resources to the data backup system;
(C) analyzing, by the ransomware detection system, the first resource, using the first machine learning model, the analyzing occurring prior to transmission of the second resource to the data backup system;
(D) determining, by the ransomware detection system, prior to transmission of the second resource in the plurality of resources to the data backup system, based on the analysis, that the first resource is anomalous; and
(E) transmitting, by the ransomware detection system, an alert of the determination that the first resource is anomalous.

2. The method of claim 1, wherein (A) further comprises generating the first machine learning model associated with the first type of resource based on a type of user associated with the at least one resource.

3. The method of claim 1, wherein (A) further comprises generating the first machine learning model associated with the first type of resource based on an attribute of the plurality of resources.

4. The method of claim 1, wherein (A) further comprises generating the first machine learning model associated with the first type of resource based on an attribute of a computing device transmitting the plurality of resources to the data backup system.

5. The method of claim 1, wherein (A) further comprises generating, by the ransomware detection system, a second machine learning model associated with a second type of resource associated with at least one resource in the plurality of resources.

6. The method of claim 5, wherein (B) further comprises determining that the first resource is associated with the second type.

7. The method of claim 6, wherein (C) further comprises analyzing, using the second generated machine learning model, the first resource.

8. The method of claim 1, wherein (C) further comprises determining that the anomalous resource includes ransomware.

9. The method of claim 1, wherein (B) further comprises determining that a second resource in the plurality of resources is associated with the first type, the determining occurring prior to transmission of a third resource in the plurality of resources to the data backup system.

10. The method of claim 9, wherein (C) further comprises analyzing, prior to transmission of a third resource in the plurality of resources to the data backup system, using the first machine learning model, the second resource.

11. The method of claim 10, wherein (C) further comprises determining, prior to transmission of the third resource in the plurality of resources to the data backup system, that the first resource and the second resource are associated with a type of anomalous behavior.

12. The method of claim 1, wherein (D) further comprises:
generating, by the ransomware detection system, an entropy score associated with the first resource; and
determining that the entropy score associated with the first resource exceeds a threshold level of entropy scores.

13. A system comprising at least one non-transitory computer-readable medium having computer program instructions stored thereon, the computer program instructions being executable by at least one computer processor to perform a method for detecting, by a ransomware detection system, via at least one resource-level entropy check during a process for transmitting a plurality of resource to a data backup system, a resource in the plurality of resources having an anomalous attribute, the method comprising:
(A) generating, by a ransomware detection system, a first machine learning model associated with a first type of resource associated with at least one resource in a plurality of resources transmitted to a data backup system;
(B) determining, by the ransomware detection system, that a first resource in the plurality of resources is associated with the first type, the determining occurring prior to transmission of a second resource in the plurality of resources to the data backup system;
(C) analyzing, by the ransomware detection system, using the first machine learning model, the analyzing occurring prior to transmission of the second resource to the data backup system;
(D) determining, by the ransomware detection system, prior to transmission of the second resource in the plurality of resources to the data backup system, based on the analysis, that the first resource is anomalous; and
(E) transmitting, by the ransomware detection system, an alert of the determination that the first resource is anomalous.

14. The system of claim 13, wherein (A) further comprises generating the first machine learning model associated with the first type of resource based on an attribute of a computing device transmitting the plurality of resources to the data backup system.

15. The system of claim 13, wherein (A) further comprises generating, by the ransomware detection system, a second machine learning model associated with a second type of resource associated with at least one resource in the plurality of resources.

16. The system of claim 15, wherein (B) further comprises determining that the first resource is associated with the second type.

17. The system of claim 16, wherein (C) further comprises analyzing, using the second generated machine learning model, the first resource.

18. The system of claim 13, wherein (B) further comprises determining that a second resource in the plurality of resources is associated with the first type, the determining occurring prior to transmission of a third resource in the plurality of resources to the data backup system and wherein (C) further comprises analyzing, prior to transmission of a third resource in the plurality of resources to the data backup system, using the first machine learning model, the second resource

19. The system of claim 18, wherein (D) further comprises determining, prior to transmission of the third resource in the plurality of resources to the data backup system, that the first resource and the second resource are associated with a type of anomalous behavior.

20. The system of claim 13, wherein (D) further comprises:
generating, by the ransomware detection system, an entropy score associated with the first resource; and
determining that the entropy score associated with the first resource exceeds a threshold level of entropy scores.
